(19) United States
(12) Patent Application Publication
(10) Pub. No.: US 2003/0110903 A1
(43) Pub. Date: Jun. 19, 2003

(54) Insert for socket wrench

(76) Inventor: James M. Creek, Buffalo, NY (US)

Correspondence Address: HODGSON RUSS LLP, INTELLECTUAL PROPERTY LAW GROUP, ONE M & T PLAZA, SUITE 2000, BUFFALO, NY, 14203-2391, US

(21) Appl. No.: 10/023,927

(22) Filed: Dec. 18, 2001

(51) Int. Cl. B25B 13/02

(52) U.S. Cl. 81/125

(57) ABSTRACT

An insert for a socket wrench comprises a polygonal base corresponding in shape to a wrenching socket into which the insert is received, and a plurality of elongated fingers extending from corner locations on the base. Each finger is characterized by a cross-sectional shape that provides a vertex edge registering with a corresponding corner of the wrenching socket, a pair of confinement sides intersecting at vertex edge for registering with adjacent flats of the wrenching socket, and an engagement side opposite the vertex edge for contacting an intermediate portion of a flat of the fastener between the rounded “corners” of the stripped fastener polygon. The insert efficiently transmits torque to the fastener in a non-destructive manner to loosen, or if desired tighten, the stripped fastener. The finger configuration of the invention can also be integrally incorporated into a socket attachment for a socket wrench.

### BACKGROUND OF THE INVENTION

1. Field of the Invention

The present invention relates generally to socket wrenches, and more particularly to an improved insert for a socket wrench that makes the wrench suitable for removing “stripped” fasteners having rounded edges between flats.

2. Description of the Related Art

Several devices have been made to allow a user to remove “stripped” fasteners. “Stripped” fasteners are fasteners having a polygonal cross-sectional shape for receiving a torque applying tool, wherein the corners of the polygon are worn off and rounded by repeated attempts to apply torque to the fastener where slippage has occurred between the fastener and the torque applying tool. Commonly, the fastener is a hex-head bolt, hex-head screw, or a hex nut, and the torque applying tool is a socket wrench having a hexagonal wrenching socket such as that provided by a socket attachment releasably connectable to a wrench handle. When the fastener has become stripped, conventional wrenches cannot apply sufficient torque, as they generally engage the corners rather than the flat surfaces between the corners.

U.S. Pat. No. 4,416,173 (Rebish) discloses an insert device made of six parallel cylindrical pins connected by a retainer. It is placed inside a standard sized socket of a socket wrench (the socket being larger than the fastener desired to be removed) such that each cylindrical pin registers with a corner of the wrenching socket. As force is applied to the wrench handle, the cylinders seat against flat sides of the fastener head. The surfaces of the cylinders engage the flat sides of the fastener to allow torque to be transferred from the wrench to the fastener. This device requires assembly during manufacture, as the six pins need to be connected to the retainer. In addition, torque is applied to the stripped fastener through the narrow interface between the cylinders and the flat sides of the fastener. This may limit the amount of torque that can be applied through this device before it deforms or fails.

The Lisle Corporation of Clarinda, Iowa has disclosed a Bolt and Stud Remover Set 19250. This bolt and stud remover comprises a hexagonal solid with a hole drilled through it. Splines stick out of the structure into the central, cylindrical space. The bolt remover is hammered onto the stripped fastener head such that the splines in the bolt remover dig into the sides of the fastener head. The hexagonal solid of the bolt remover receives a conventional wrench for transferring torque to the stuck fastener. This, however, necessarily damages the fastener head, preventing the user from using this device on a particular fastener more than a few times (possibly only once). Also, there is a risk that if the fastener cannot be removed by this device, other devices will be rendered ineffective as well because the fastener flats will be compromised along with the originally stripped corners, leaving little to work with to apply torque.

U.S. Pat. No. 4,805,495 (Tauber) discloses a similar system to that of the Lisle Corporation. A hexagonal solid has a cutout of a hex head at one end, and is hammered over a stuck fastener. However, the hex head indentation is smaller than a standard sized head. Thus, the stuck fastener head is trimmed down to a smaller size that will have sharper corners. Both of these devices require use of a hammer, and deform the fastener head. The Tauber device may change the head to a non-standard size.

Thus, there is a need for a nondestructive, easily manufactured fastener wrench insert that is self-aligning and provides more surface area through which torque can be applied to the stripped fastener.

### BRIEF SUMMARY OF THE INVENTION

Therefore, it is a primary object of the present invention to provide an insert for a socket wrench that will aid in the removal of stripped fasteners.

It is another object of the present invention to provide an insert for a socket wrench that achieves the primary object stated above and is of a simple, unitary construction.

It is yet another object of the present invention to provide an insert for a socket wrench that achieves the primary object stated above and that remains in place within a wrenching socket of the socket wrench by frictional forces.

It is yet another object of the present invention to provide an insert for a socket wrench that achieves the primary object stated above and that is self-aligning with respect to the fastener as torque is applied.

In furtherance of these and other objects, an insert of the present invention comprises a polygonal base corresponding in shape to a wrenching socket into which the insert is received, and a plurality of elongated fingers extending from corner locations on the base. Each finger is characterized by a cross-sectional shape that provides a vertex edge registering with a corresponding corner of the wrenching socket, a pair of confinement sides intersecting at vertex edge for registering with adjacent flats of the wrenching socket, and an engagement side opposite the vertex edge for contacting an intermediate portion of a flat of the fastener between the rounded “corners” of the stripped fastener polygon. The insert efficiently transmits torque to the fastener in a non-destructive manner to loosen, or if desired tighten, the stripped fastener.

The configuration of the present invention may also be integrally incorporated into a socket attachment for a socket wrench, as opposed to being provided as an insert.

### BRIEF DESCRIPTION OF THE SEVERAL VIEWS OF THE DRAWINGS

The nature and mode of operation of the present invention will now be more fully described in the following detailed description of the invention taken with the accompanying drawing figures, in which:

FIG. 1 is a perspective view of an insert for a socket wrench formed in accordance with a preferred embodiment of the present invention, together with a socket attachment having a wrenching socket for receiving the insert;

FIG. 2 is an enlarged cross-sectional view showing use of the insert in removing a stripped fastener;

FIG. 3 is an enlarged end view of an insert for a socket wrench formed in accordance with an alternative embodiment of the present invention; and

FIG. 4 is a perspective view of a socket attachment formed in accordance with the present invention.

### DETAILED DESCRIPTION OF THE INVENTION

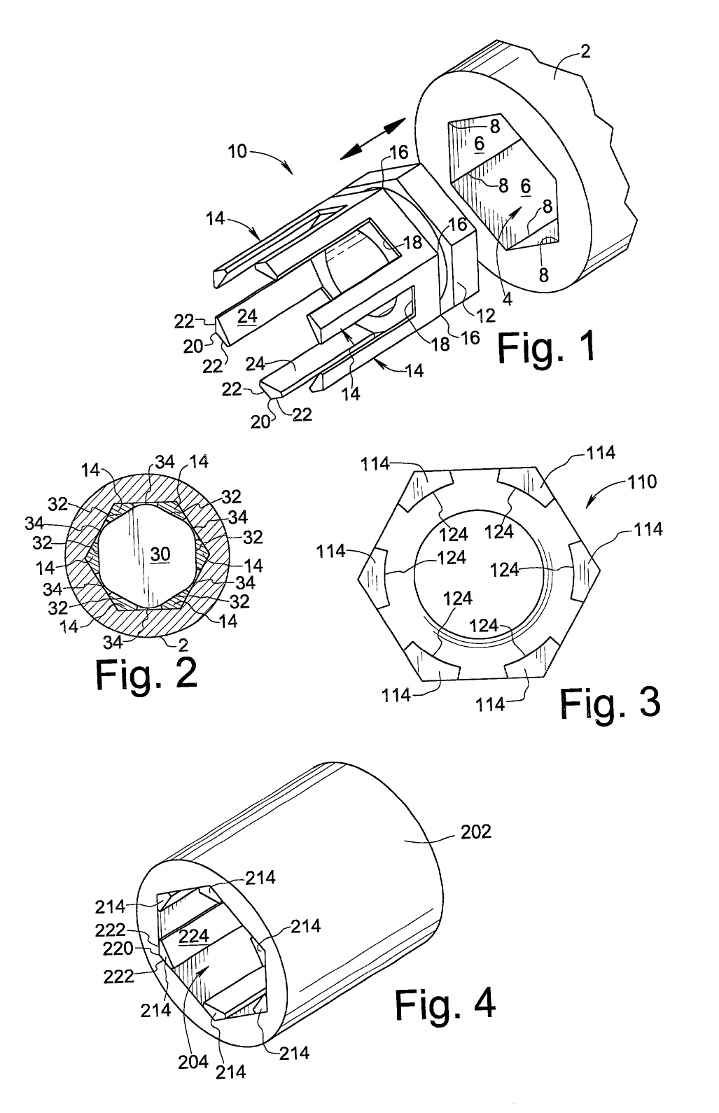

FIGS. 1 and 2 show an insert 10 formed in accordance with a preferred embodiment of the present invention and intended for receipt within a polygonal wrenching socket 4 of a socket attachment 2 that is in turn connected to torque providing means (not shown), typically a wrench handle, ratchet handle, or automatically powered driver. Polygonal wrenching socket 4 includes a plurality of flats 6, with adjacent flats intersecting to define a plurality of corners 8 as is well established in the socket wrench art.

Insert 10 generally comprises a base 12 corresponding in shape to polygonal wrenching socket 4 and sized for slidable receipt therein, and a plurality of elongated fingers 14 each extending from a respective corner location 16 of base 12 in a common axial direction. Fingers 14 are spaced from one another by slots or gaps 18. As best seen in FIG. 2, each finger 14 has a cross-sectional shape providing a vertex edge 20 registering with a corresponding corner 8 of wrenching socket 4, a pair of confinement sides 22 intersecting at vertex edge 20 and registering with adjacent flats 6 of the wrenching socket, and an engagement side 24 opposite vertex edge 20. In the preferred embodiment presently described, the confinement sides 22 of each of the fingers form an angle substantially equal to an angle formed by adjacent flats 6 of wrenching socket 4 with which the confinement sides are registered. Preferably, one finger 14 is provided for each of corner 8 of wrenching socket 4 for distributing torque evenly about the fastener.

FIG. 2 further shows a stripped fastener 30, typically a nut or bolt, having a plurality of flats 32 and rounded “corners” 34 connecting adjacent flats 32. When socket attachment 2 is positioned over fastener 30, the engagement sides 24 of fingers 14 are in surface-to-surface engagement with the intermediate region of each fastener flat 32 between the rounded corners 34, and confinement sides 22 are in surface-to-surface engagement with associated flats 6 of wrenching socket 4. Consequently, as torque is applied to socket attachment 2, fingers 14 of insert 10 are captively wedged in place to transmit torque to the fastener flats 32 without slippage, regardless of the angular direction in which torque is applied. It is therefore preferred to form each engagement side 24 as a flat surface for maximizing surface area contact with an associated fastener flat 32.

An additional preferred feature of insert 10 is that fingers 14 are flared slightly outward relative to one another as they extend from base 12. When insert 10 is inserted within wrenching socket 4, the fingers are elastically deformed so as to provide a spring force bearing against the wall of the wrenching socket, whereby the insert is held within the wrenching socket by friction.

Insert 10 of the preferred embodiment can be manufactured by an Electrical Discharge Machine (EDM) from 4140 alloy steel or other suitable material. It is contemplated to provide insert 10 in various standard sizes to agree with standard socket sizes.

FIG. 3 shows an insert 110 formed in accordance with an alternative embodiment of the present invention that is substantially similar to the first embodiment described above. Insert 110 is better suited than insert 10 of the first embodiment for non-EDM manufacture. More specifically, a central hole can be drilled to help form fingers 114 such that the engagement side 124 of each finger is in the form of a slightly concave arcuate surface.

Inserts 10 and 110 of the present invention are designed as to be unitary in construction to make the insert durable and to avoid assembly of separately manufactured component parts.

FIG. 4 shows a socket attachment 202 for a socket wrench that integrally incorporates the effective finger structure of the present invention to avoid the need for a separate insert. A wrenching socket 204 of socket attachment 202 is of a conventional shape, except that it further includes a plurality of elongated fingers 214 each extending along a corresponding corner of the wrenching socket. In accordance with the present invention, each finger 214 has a cross-sectional shape providing a vertex edge 220 registering with a corresponding corner of the wrenching socket, a pair of confinement sides 222 intersecting at the vertex edge and registering with adjacent flats of the wrenching socket, and an engagement side 224 opposite vertex edge 220 for engaging a flat on a fastener.

As will be appreciated from the foregoing description, the socket wrench insert and socket attachment of the present invention, when combined with a standard socket wrench, provides an excellent tool that is fast and easy to use for removing stripped nuts and bolts. Moreover, the socket wrench insert and socket attachment of the present invention may be used on a regular basis for tightening and loosening fasteners to prevent the fasteners from becoming stripped.

What is claimed is:

1. An insert for a socket wrench having a polygonal wrenching socket which provides flats and corners at the intersection of adjacent flats, said insert comprising:
a base sized for receipt within said wrenching socket, said base having a plurality of corners corresponding to corners of said wrenching socket; and
a plurality of elongated fingers each extending from a respective one of said plurality of corners of said base;
wherein each of said plurality of fingers has a cross-sectional shape providing a vertex edge registering with a corresponding corner of said wrenching socket, a pair of confinement sides intersecting at said vertex edge and registering with adjacent flats of said wrenching socket, and an engagement side opposite said vertex edge for engaging a flat on a fastener.

2. The insert according to claim 1, wherein said confinement sides of each of said fingers form an angle substantially equal to an angle formed by adjacent flats of said wrenching socket with which said confinement sides are registered.

3. The insert according to claim 1, wherein said plurality of fingers comprises one finger for each of said corners of said wrenching socket.

4. The insert according to claim 1, wherein said plurality of fingers are flared slightly outward relative to one another as said plurality of fingers extend from said base such that said plurality of fingers are elastically deformed when said insert is received by said socket, whereby said insert is held within said wrenching socket by friction.

5. The insert according to claim 1, wherein said insert is unitary in construction.

6. The insert according to claim 1, wherein said engagement side is a flat surface.

7. The insert according to claim 1, wherein said engagement side is a concave arcuate surface.

8. A socket attachment for a socket wrench, said socket attachment comprising:
a polygonal wrenching socket which provides flats and corners at the intersection of adjacent flats;
a plurality of elongated fingers each extending along a corresponding corner of said wrenching socket;
wherein each of said plurality of fingers has a cross-sectional shape providing a vertex edge registering with said corresponding corner of said wrenching socket, a pair of confinement sides intersecting at said vertex edge and registering with adjacent flats of said wrenching socket, and an engagement side opposite said vertex edge for engaging a flat on a fastener.

9. The socket attachment according to claim 8, wherein said plurality of fingers comprises one finger for each of said corners of said wrenching socket.

10. The socket attachment according to claim 8, wherein said insert is unitary in construction.

11. The insert according to claim 8, wherein said engagement side is a flat surface.

12. The insert according to claim 1, wherein said engagement side is a concave arcuate surface.
